(19) United States
(12) Patent Application Publication
(10) Pub. No.: US 2013/0268526 A1
(43) Pub. Date: Oct. 10, 2013

(54) DISCOVERY ENGINE

(71) Applicants: Mark E. Johns, Gaithersburg, MD (US); Chris McKinzie, Lakeway, TX (US)

(72) Inventors: Mark E. Johns, Gaithersburg, MD (US); Chris McKinzie, Lakeway, TX (US)

(21) Appl. No.: 13/441,123

(22) Filed: Apr. 6, 2012

(51) Int. Cl. G06F 17/30

(52) U.S. Cl. 707/730; 707/E17.014

(57) ABSTRACT

A searching/discovery engine is disclosed wherein the searching methodology may involve selecting at least one category of sources; selecting at least one source (i.e. a collection of documents) within at least one category of sources; utilizing search terms to search the at least one source; returning related documents from the at least one source based on the search terms; collecting any of the related documents into a collection; permitting at least one related document returned to be selected for a further search utilizing the entire text of the at least one related document as the search criteria in a selected source to return additional related documents; and exporting the collection of related documents by creating a Uniform Resource Locator (URL) with all of the collected related documents stored at a location referenced in the URL.

### CROSS REFERENCE TO RELATED APPLICATIONS

This United States non-provisional patent application does not claim priority to any United States provisional patent application or any foreign patent application.

### FIELD OF THE DISCLOSURE

The disclosures made herein relate generally to the search engine and discovery engine industry. The invention discussed herein is in the general classification of a device and methodology for conducting a search of electronically stored documents and collecting, storing and sharing the related documents found through the search.

### BACKGROUND

This section introduces aspects that may be helpful in facilitating a better understanding of the invention. Accordingly, the statements of this section are to be read in this light and are not to be understood as admissions about what is in the prior art or what is not in the prior art.

Most individuals are familiar with manual searching for books, magazines or documents in a library or similar setting. Searching, in its most rudimentary form, often simply involves a researcher seeking a specific book written by a particular author by perusing the library stacks by category type and utilizing alphabetical order or some other organizational scheme to locate the specific book.

Searching for documents stored electronically often involves searching within a specific database via names or key words/search terms. When a researcher must independently search each database, he will only uncover documents stored in the selected database that relate to the search terms, and he will not uncover any related documents stored in other databases. This creates an organizational problem in that different researchers may search different databases attempting to find the same type of documents. In other words, two different researchers may think that a given document they are searching for should be contained in two different databases due to their own notions of the proper categorization of the searched for document. As a result, one or both researchers may not discover the document that they are searching for due to their failure to classify the document in the same manner as the creator of the database and their failure to search the database deemed appropriate by the database creator.

With the advent of the Internet, millions of documents are available through Internet search engines. An electronic document is a cohesive body of text that is electronically accessible (e.g. a patent document, a news article, a legal case, a medical journal article or a webpage). Often, a group of documents are contained within a single source, dataset, collection or database. Most individuals are familiar with the process of searching for relevant documents within a document collection via keywords and search terms. A researcher types the key words/search terms into the search engine to locate related documents and then sifts through the document results to determine which documents are most relevant.

If the researcher is satisfied with the results he obtains via the key word search, he can print or save the documents and complete the search. However, often the researcher is not satisfied with the initial results and the query (i.e. key words or search terms) must be modified to obtain potentially better results. After a number of searches are performed, the researcher often collects and organizes the results by printing the documents or saving the documents into a folder. The problem with this searching methodology is twofold. First, the results of the search are dependent on the researcher's selection of key words. The researcher may not select the best key words or may not be able to obtain the best results by simply using a few words and may obtain no results by using too many terms. Second, the document results saved or printed are not “living” documents in that they represent how the document appeared when the document was saved or printed. They are not dynamic and capable of being updated and then viewed at a later date without further researcher involvement. The document results are also a snapshot of the search conducted at a given point in time and any documents added to the dataset after the search will not be included in the search results.

Keyword searching is still quite analogous to manually investigating a collection of printed documents. Software essentially just helps to perform that job more efficiently. The advent of the search engine was a cornerstone in the evolution of information research, but a search engine simply finds documents that contain some specific words.

Advanced search engines such as Google are forgiving in the sense that they can yield results that do not literally match on the keywords and allow the researcher to utilize natural language. Search engines, such as Google, utilize a “Page Rank” that may skew results from any given search. “Page Rank” involves a link analysis algorithm that assigns a value to each element of a set of documents to determine a document's relative importance within the set of documents. The value assigned to a document/webpage on the World Wide Web is defined recursively and is calculated based on the number and “Page Rank” of all webpages that link to the document with the theory being that a document linked to by many webpages with high “Page Ranks” is also worthy of a high “Page Rank.”

Semantics also play a role in natural language queries in which “unimportant” words such as “the” and “it” are discarded while the “important” words and synonyms to those “important” words are actually searched which may ultimately create a huge index that still needs to be manually inspected by the researcher.

Other database search engines (e.g. search engines for Wikipedia and the United States Patent and Trademark Office) utilize the familiar “Boolean keyword search” that is very literal and has its own distinct value and applicability. If a researcher types in too many keywords, no matches appear. If a researcher types in too few keywords, there are too many and highly varying results. If a researcher is unsatisfied with the results, he must rework the query by adding some complex operators (e.g. some combination of “AND”, “OR”, “NOT”, and/or parentheses).

If a researcher is unfamiliar with the nuances of the Boolean keyword search system, he may not properly utilize the Boolean operators and may not structure the query in the proper manner to obtain the most desirable results. Moreover, a Boolean search is traditionally unforgiving in that the search terms entered are either present or they are not present in the selected range (e.g. in the entire document or in the same sentence as one another).

Key word searching also may be difficult to perform in certain situations because of the different meaning of given words (e.g. China and china), causing a large number of varying search results that need to be perused by a researcher.

Current solutions do not allow for electronic searching for documents utilizing an entire document or documents as the search criteria or utilizing portions of a document supplemented with key words entered by a researcher as the search criteria. Other solutions also do not permit collection, storage and sharing of the documents found during this type of searching in a portable and dynamic manner.

The prior art searching technology simply allows a researcher to enter some keywords for searching that may yield a set of documents that at least come close to the type of documents sought. Upon reviewing these documents, if a researcher discovers some words in a related document that help him develop his search criteria, the prior art solutions require him to enter those key words from that related document as search terms to try to locate additional relevant documents. The context of the language preceding and following those key words from the related document is lost when a new key word search is performed using this traditional searching technique. The prior art does not allow the researcher to leverage the entirety of that particular related document as the criteria for the next search.

In many document collections, the highest quality search criterion is actually the entire text of one of the documents in the database. A real document in the collection (or a new one that the researcher types in full) contains much more useful information than what a researcher typically types as keywords. The natural language of the document and all of its inherent properties tend to shine through, if analyzed with appropriate algorithms. When the text of an entire document or large portions of text thereof are used as the search criteria, the set of related documents returned are most similar to or related to the original document or portions thereof. In “complexity theory” this phenomenon is known as “emergence.” Emergence is the key to a natural stepping-stone in the evolution of information research from a “search engine” to a “discovery engine.”

A researcher conducting a document search, such as a patent search, could leverage a “discovery engine” as opposed to a “search engine” to obtain superior results. In this type of search, the researcher already has a full description of the patent/document. The description can be submitted as the search criteria and the top related documents can be returned. Some of the results may look very relevant and the researcher can hold/identify these documents to enable him to return to them later. The researcher also can identify others to ignore so they do not show up as results again. If one of the documents discovered looks extremely relevant, the researcher can perform a further search using that entire relevant document as the search criteria to view the top related documents to that relevant document. The search criteria is effectively changing each time a search is performed without having to rework a query manually each time based on search results.

Hence, there is a need for a device and methodology that efficiently, reliably and affordably permit a user to utilize the text of an entire document as the search criteria and/or to utilize an entire document along with supplemental text supplied by a researcher or multiple documents or subsections of documents as the search criteria. There is also a need for a device and methodology that permit a user to collect, store and share the collected/related documents from a search with other users and to further permit any individual to conduct an updated search for any newly added documents in a dataset based on the same search criteria.

### SUMMARY OF THE DISCLOSURE

The preferred device includes a memory containing a set of instructions and a processor for processing the set of instructions. The set of instructions include instructions for selecting at least one category of sources (either automatically or through user selection); selecting at least one source (i.e. a collection of documents) within at least one category of sources (either automatically or through user selection); utilizing search terms to search the at least one source; returning related documents from the at least one source based on the search terms; collecting any of the related documents into a collection; permitting at least one related document returned to be selected for a further search utilizing the at least one related document as the search criteria in a selected source to return additional related documents; and exporting the collection of related documents by creating a Uniform Resource Locator (URL) with all of the collected related documents stored at a location referenced in the URL.

In certain embodiments the set of instructions may also include instructions for utilizing a document such as a webpage to automatically conduct a search of designated sources for documents related to the document based on the content of the document and instructions for displaying the related documents found in the search in a collection and storing the collection under a single URL that can be utilized to display the collection.

The preferred methodology for searching a collection of electronically stored documents involves: selecting at least one category of sources; selecting at least one source (i.e. a collection of documents) within at least one category of sources; utilizing search terms to search the at least one source; returning related documents from the at least one source based on the search terms; collecting any of the related documents into a collection; permitting at least one related document returned to be selected for a further search utilizing the at least one related document as the search criteria in a selected source to return additional related documents; and creating a URL with all of the collected related documents stored at a location referenced in the URL.

The step of collecting any of the related documents into a collection may involve identifying the related documents to be collected from each source. The step of collecting documents may be performed to collect additional related documents after any search.

The preferred methodology may further involve sharing the relevant documents by sending the URL to select other users via any electronic method, including social networking websites and electronic mail services.

In certain embodiments, the preferred methodology may involve utilizing a document such as a webpage to automatically conduct a search of designated sources for documents related to the document based on the contents of the document and displaying the related documents found in the search in a collection and storing the collection under a single URL that can be utilized to display the collection.

Under some applications, embodiments may provide a method that is relatively inexpensive to implement that permits a user to conduct searches of electronically stored documents using an entire document, multiple documents or portions of a document as the search criteria and to collect, store and share the relevant documents from the search.

Under some applications, embodiments may provide a device and method that are not operationally complex that permit a user to conduct searches of electronically stored documents using an entire document, multiple documents or portions of a document as the search criteria and to collect, store and share the relevant documents from the search.

Under some applications, embodiments may provide a device and method that efficiently permit a user to conduct searches of electronically stored documents using an entire document, multiple documents or portions of a document as the search criteria and to collect, store and share the relevant documents from the search.

Under some applications, embodiments may provide a reliable device and method that permit a user to conduct searches of electronically stored documents using an entire document, multiple documents or portions of a document as the search criteria and to collect, store and share the relevant documents from the search.

Under some applications, embodiments may provide better search results than traditional Boolean or natural language searches utilizing only search terms input by a user by utilizing an entire document, documents, portions of documents or portions of documents supplemented with user input search terms.

Under some applications, embodiments may provide more conveniently collected, stored and shared documents and document collections.

Under some applications, embodiments may provide more dynamic search results that can be constantly updated without user involvement due to the nature of the searching and storage of the search results.

Under some applications, embodiments may provide searching technology that does not require the use of an extreme amount of computer resources.

Under some applications, embodiments of the preferred methodology form a paradigm that is fundamentally sound and extensible (e.g. multiple documents, an existing document that is augmented with some text supplied by the researcher or subsections of documents can be used as the search criteria to point to other related documents).

### BRIEF DESCRIPTION OF THE DRAWINGS

Some embodiments of apparatus and/or methods of the present invention are now described, by way of example only, and with reference to the accompanying drawings, in which:

FIG. 1 depicts the preferred embodiment of the device for implementing the method of searching a source of electronically stored documents and collecting, storing and sharing the related documents from the search.

FIG. 2 depicts a screen shot of an exemplary sign-in webpage used in accessing a website to perform the preferred methodology for searching a source of electronically stored documents.

FIG. 3 depicts an interactive webpage for use in setting up the search environment in the preferred embodiment.

FIG. 4 depicts an interactive webpage for use in conducting a search associated with the preferred embodiment.

FIG. 5 depicts another interactive webpage for use in conducting a search associated with the preferred embodiment.

FIG. 6 depicts another interactive webpage for use in conducting a search associated with the preferred embodiment.

FIG. 7 depicts a webpage displaying a collection with each document/webpage having a table associated therewith.

FIG. 8 displays a webpage displaying an electronic magazine (electronic document collection) that can be stored and shared via a single URL.

FIG. 9 depicts the preferred methodology of searching, collecting, storing and sharing electronic documents.

FIG. 10 depicts the preferred methodology of creating an electronic collection of related documents from a variety of sources based on the entire text of a single electronic document.

### DETAILED DESCRIPTION OF THE DRAWINGS

It is contemplated that the method described herein can be implemented as software, including a computer-readable medium having program instructions executing on a computer, hardware, firmware, or a combination thereof. The method described herein also may be implemented in various combinations on hardware and/or software.

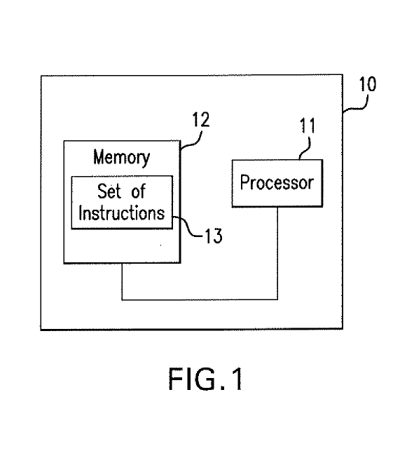

FIG. 1 depicts the preferred embodiment of the device for implementing the method of searching a source of electronically stored documents and collecting, storing and sharing the related documents from the search. The device 10 has a memory 12 containing a set of instructions 13 and a processor 11 for implementing the set of instructions 13. The set of instructions 13 may include instructions for: allowing a user to sign into an account using any of a plurality of approved website accounts; selecting at least one category of sources; selecting at least one source (i.e. a collection or set of documents) within at least one category of sources; utilizing search terms/criteria to search the at least one source; returning related documents from the at least one source based on the search terms; collecting any of the related documents into a collection; permitting at least one related document returned to be selected for a further search utilizing the content of the at least one related document as the search criteria in a selected source to return additional related documents; creating a Uniform Resource Locator (URL) with the collection stored at a location referenced in the URL; and exporting the collection of related documents by sending the URL associated with the collection to other selected users via any electronic method, including social networking websites and electronic mail services.

In certain embodiments, default categories and sources are utilized, allowing the categories and sources to be automatically selected without user involvement.

The set of instructions 13 may further include instructions wherein collecting any of the related documents into a collection involves identifying the related documents to be stored from the at least one source.

Alternatively, the set of instructions 13 may include instructions for utilizing a document such as a webpage to automatically conduct a search of designated sources for documents related to the document based on the content in the document and instructions for displaying the related documents found in the search in a collection and storing the collection under a single URL that can be utilized to display the collection.

In conducting a search of a source, also known as a dataset, for other documents related to a document based on the content/text in the document, a computing process must be run that assimilates the entire dataset to prepare the necessary data structures. Thereafter, any document whether it resides in the dataset or not, can have its similarity score calculated against every document in the dataset.

For each document in a dataset, the computing process should parse out the relevant text from any markup. For example, if the markup language in a document contains <title> Searching Techniques <title>, the relevant text “Searching Techniques” is parsed out and the two instances of <title> in the markup language are removed. By further way of example, parsing out relevant text may also involve only utilizing the text of a blog article and ignoring the comments contained in the blog. Often the comments in a blog are drafted by numerous authors, resulting in inconsistent and/or inaccurate term usage. Hence, a researcher may determine that counting the appearances of certain terms/words by including the blog comments may not increase the accuracy of search results.

The computing process should also lowercase or uppercase all letters in the text of documents in the dataset and may correct misspellings. This approach helps create consistency when terms are being counted and compared between any two documents. The computing process must also determine tokens in each document. For example, each word in a document can be considered a token.

The computing process should further remove tokens that are stopwords. For example, definite and indefinite articles or transitional phrases should be removed as they are less likely to be useful in determining similarity scores between documents.

The computing process should also stem each token in the documents. Stemming each token may involve removing prefixes and suffixes from words to utilize them in the similarity calculation between two documents.

The computing process may also transform phrases into individual tokens by, for example, taking a multiword phrase and making it into a single token in all documents.

The computing process may also associate each token with particular sections of the document. For example, a word that is used in the title may be weighted more heavily than the same word being used in the regular text of the document (e.g. the frequency count for that token may be transformed/increased to account for a token's use in the title).

The computing process must also generate a frequency count of tokens for each document. The computing process may transform the count of any given token based on the sections it is associated with and may also normalize the counts such that the length of the document is less relevant or not relevant. For example, ten occurrences of a word in a single page document could be normalized to be equivalent to fifty occurrences of the same word in a five page document.

The computing process may also transform the token counts in ways deemed appropriate for the language or nature of the dataset. In certain languages, certain words may have more significance than other words in that same language. Hence, certain words may be weighted more heavily in conducting a similarity calculation.

The computing process may also involve calculating other statistics that apply to each token. For example, a word's distance away from the front of a document may be calculated and used to transform the token counts, if desired.

The computing process must invert the data such that each token has a set of documents it resides in, along with the associated counts for each token and potentially other statistics obtained through the computing process.

The computing process may, for each token in the set of unique tokens in the dataset, determine a numeric value that measures the magnitude of its significance in the dataset. For example, a word that occurs few times in the dataset may be deemed more important than a word that occurs many times in the entire dataset. This step of the computing process related to determining a numeric value that measures the magnitude of each token's significance in the dataset is not used in transforming any of the data from the other steps. If such a transformation did occur, then whenever new documents were added to the dataset, all or many of the other steps (or subsets of these steps) of the computing process would need to be rerun. This type of duplicative processing would be expensive. Moreover, if a user wanted to alter the weighting assigned to the step of determining a numeric value that measures the magnitude of each token's significance in the dataset to determine how it affects the quality of the similarity scores, all or many of the steps would also need to be rerun.

For any given document of text (or in some cases simply text typed in by a user or input from multiple documents), a similarity calculation determines for each other document in the dataset a numeric similarity score. The computing process to determine the similarity score involves, with the possible aid of the statistics calculated during the computing process, comparing each token's count in a designated document (or text) to its matching token's count in each other document in the dataset. For a given token, the magnitude of closeness of the two such token counts between two documents has a directly proportional contribution to the magnitude of the similarity score (i.e. the closer the token counts are for each token included in two compared documents, the more significant the contribution to improving the similarity score).

The computing process to determine the similarity score may further involve including an inversely proportional contribution to the magnitude of the similarity score for tokens that are in the designated document but not in another document in the dataset being compared to the designated document or for tokens that are not in the designated document but are in another document in the dataset being compared to the designated document. A token with a high token count in a first document that does not appear at all in a second document being compared to the first document will make a more significant contribution to reducing the magnitude of the similarity score than a token with a low token count in a first document that does not appear at all in a second document being compared to the first document. Moreover, the greater the number of tokens that appear in a first document and not in a second document being compared to the first document and vice versa, the more significant the contribution to reducing the magnitude of the similarity score.

Whenever the step of determining a numeric value that measures the magnitude of each token's significance in the dataset is utilized in the computing process, a given token's value of significance has a directly proportional contribution to the magnitude of the similarity score between two documents. In other words, if a particular token's value of significance is high, then the closeness of that particular token's count between documents is of increased importance in the similarity calculation between those documents. In the preferred embodiment, this means that if a given token count is exactly the same in a designated document and a compared document, the higher the value of significance for that particular token, the more favorable impact that exact token match will have in the similarity calculation between the documents.

The similarity calculation should be applied in such a manner that a perfect similarity score between two documents can only be obtained if all of the token counts in the designated document match all of the token counts in the compared document and all of the token counts in the compared document match all of the token counts in the designated document and all such token values of significance for all tokens in the designated document and the compared document are equal to the maximum value in the entire set of values of significance (i.e. the maximum value of significance given to any token in the dataset must be given to each token in the documents).

By conducting such a similarity calculation for all documents in a dataset, the top N most similar documents or least similar documents to a designated document or text can then easily be obtained. A given similarity score is consistently comparable to any other similarity score in the dataset, but it may not be comparable to a similarity score calculated by passing the designated document through some other entirely different dataset. Because the process defines that a similarity score is calculated for every document in the dataset, that total set of similarity scores can be used to normalize each of those similarity scores to something comparable across datasets. Given extremely normalized similarity scores, a given designated document can yield a useful single set of similar documents derived from multiple datasets, by applying the condition that a given normalized similarity score is beyond some standard threshold. It is important to note that while a high similarity score may often be better based on the computing process, it can also be the case that a low or average score would produce the best match of similar or dissimilar documents in certain situations.

To implement the above-described computing process for searching a source, also known as a dataset, for other documents related to a document based on the content in the document (i.e. the text of the document used as the search criteria), the set of instructions 13 may further include instructions for: parsing out the relevant text from any markup in a document and all documents in the source; lowercasing or uppercasing all letters in the text of a document and all documents in the source; correcting misspellings of words in a document and all documents in the source; determining tokens in a document and all documents in the source; removing tokens that are stopwords from the document and all documents in the source; stemming each token in the document and all documents in the source; transforming phrases into individual tokens in the document and all documents in the source; associating each token with a particular section in the document and all documents in the source; obtaining a frequency count of the tokens for the document and all documents in the source; transforming the count of any given token based on the sections it is associated with in the document and all documents in the source; normalizing the counts of the tokens for the document and all documents in the source; transforming the counts of the tokens in ways deemed appropriate for the language or nature of the dataset for the document and all documents in the source; calculating other statistics that apply to each token in the document and all documents in the source; inverting the data such that each token has a set of documents it resides in from the source, along with the associated counts and statistics; and determining a numeric value that measures the magnitude of each token's significance in the source.

The set of instructions 13 further include instructions for: comparing each token's count in a document to its matching token's count in another document in the source wherein the magnitude of closeness of the two counts has a directly proportional contribution to the magnitude of the similarity score between those documents. The set of instructions 13 may further include instructions for: determining which tokens are present in the document but not present in other documents and vice versa in the source and including an inversely proportional contribution to the magnitude of the similarity score between the document and another document based on the magnitude of each such tokens' count and the total number of each such tokens; utilizing a token's value of significance to include a directly proportional contribution to the magnitude of the similarity score based on the closeness of a token's count between the document and each other document in the source; sorting the set of similarity scores from the source; and displaying the similarity scores from the source in ascending or descending order.

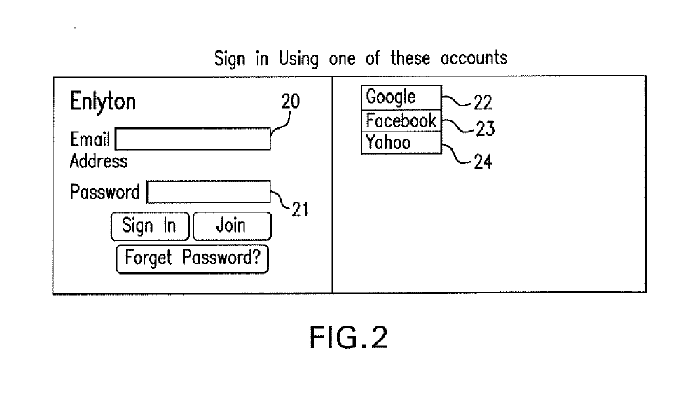

FIG. 2 depicts a screen shot of an exemplary sign-in webpage used in accessing a website to perform the preferred methodology for searching a source of electronically stored documents. In this example, a researcher can log into the Enlyton website using an e-mail address field 20 and password field 21 from any of a variety of different accounts. For example, a Google, Yahoo or Facebook account could be utilized for purposes of signing into the Enlyton website for conducting a research project utilizing the Google tab 22, the Facebook tab 23 or the Yahoo tab 24.

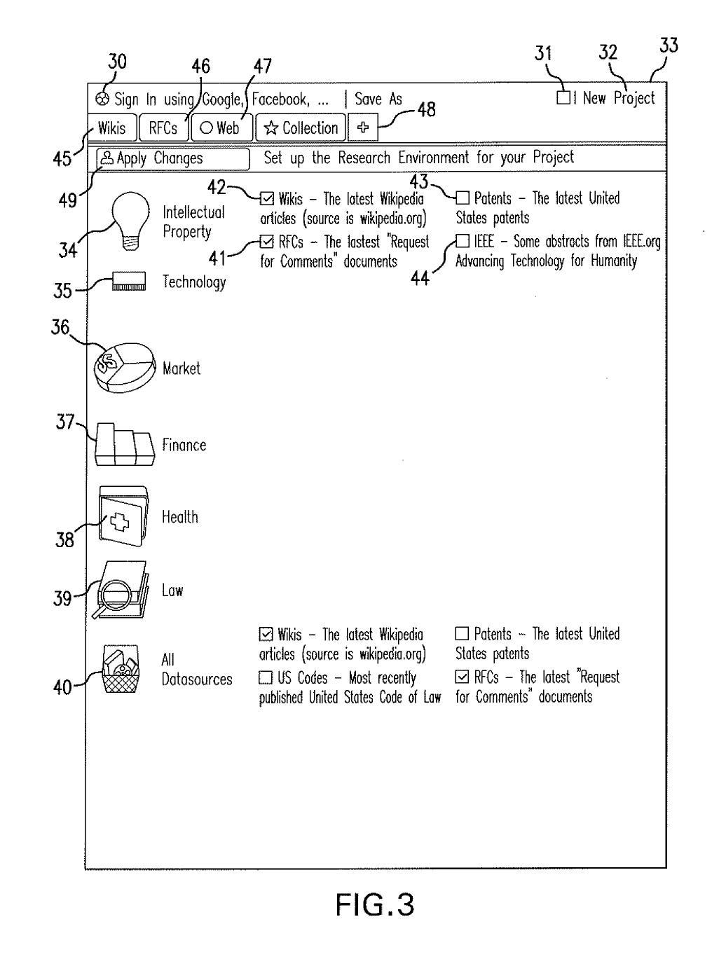

FIG. 3 depicts an interactive webpage for use in setting up the search environment in the preferred embodiment. After signing into the Enlyton website, an interactive webpage 33 is displayed. At the top of the webpage, several icons and links are displayed. One sign-in icon 30 permits a researcher to sign in from a different account (e.g. Yahoo, Google or Facebook). A disk icon 31 permits a user to save a current project by clicking on the disk icon 31 and following the instructions. Alternatively, a new project tab 32 allows a user to create a different project by clicking on it.

The interactive webpage 33 also permits the researcher to select the proper research environment for a search. For example, various categories of documents and related icons are shown on the left side of the webpage 33. These categories include: Intellectual Property 34, Technology 35, Market 36, Finance 37, Health 38, Law 39 and All Datasources 40. Obviously, the categories listed are merely illustrative and other categories of documents may also be created. The categories ideally have several different sources associated with each category which are available for searching. The All Datasources 40 is an all inclusive category wherein a researcher can select from all available sources for searching.

For example, under Intellectual Property 34, a researcher can select whether to search the Request for Comments (RFCs) 41, Wikipedia articles (Wikis) 42, the United States Patent and Trademark Office patent database (Patents) 43, the Institute of Electrical and Electronic Engineers (IEEE) articles 44 or whatever other sources are available for searching. In this embodiment, a user simply clicks in the box icon associated with any or all of these sources to create a check mark inside the associated box.

After selecting the appropriate research environment, all selected sources will appear at the top of the webpage 33 in tabs. In the example depicted in FIG. 3, the researcher has only selected Wikis 42 and RFCs 43 under the Intellectual Property category. Hence, only the Wikis tab 45 and RFCs tab 46 appear at the top of the webpage as searchable data sources along with the Web tab 47 which allows a researcher to conduct an Internet search. A plus symbol tab 48 which allows a researcher to change the research environment to add other sources at any time also appears at the top of the webpage 33. If a researcher clicks on the plus symbol tab 48, he can change the research environment and click on the apply changes tab 49 to add or subtract sources. As can also be seen in FIG. 3, the corresponding sources are also checked in the All Datasources 40 category when Wikis 42 and RFCs 41 are selected under the Intellectual Property Category 34.

After the proper research environment is created, a researcher then clicks on the desired source tabs to conduct a search specific to that source. For example, a researcher could click on the Wikis tab 45 to search the indexed Wikipedia articles related to whatever search terms the researcher inputs.

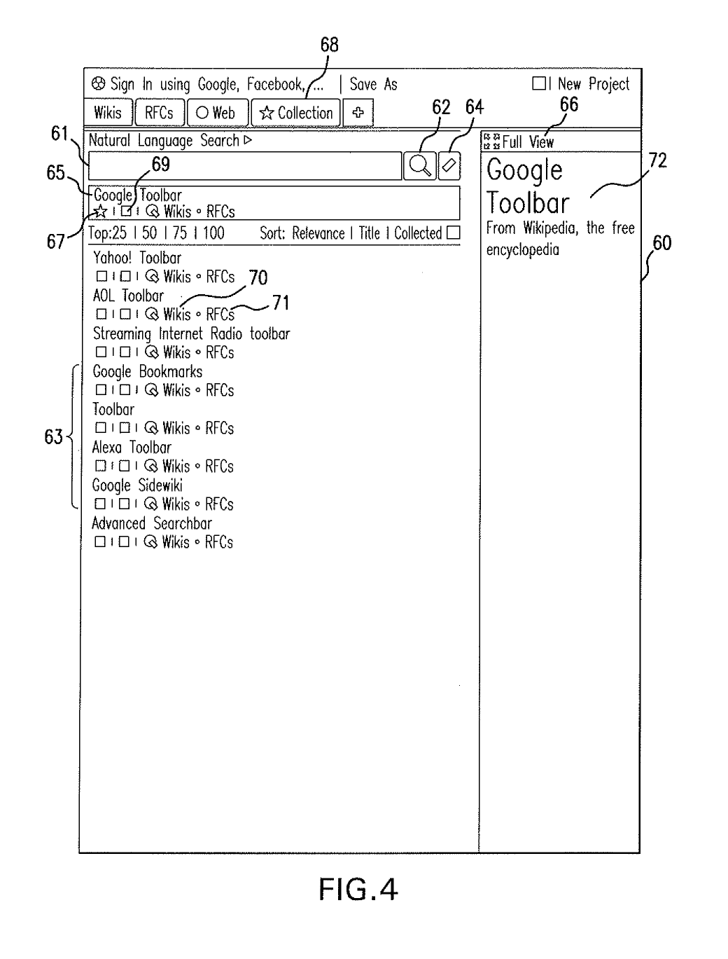

FIG. 4 depicts an interactive webpage for use in conducting a search associated with the preferred embodiment. A researcher will enter desired search terms into the natural language search box 61 shown on the interactive webpage 60. Preferably, the researcher will utilize many relevant search terms or cut and paste portions of documents or entire documents into the natural language search box 61 to create the search terms. The computing process of the preferred embodiment described in conjunction with FIG. 1 allows the entire text inserted as search terms/criteria to be utilized in conducting a search for related documents in a given source. Because the use of the entire text of the documents is often the best search criteria, the researcher is encouraged to submit as much text as possible. If a researcher desires to emphasize the importance of certain search terms, he can insert emphasis (such as three asterisks) next to certain language to accentuate this language during the searching methodology. This additional emphasis will be utilized in the computing process to increase the designated tokens' value of significance.

The natural language search box 61 allows a researcher to input text and then click on the magnifying glass icon 62 to conduct the search and return a list 63 of related documents. The researcher may also clear the dialog box by clicking on the eraser icon 64. In this example, “Google Toolbar” has been inserted into the natural language search box 61 and a search related to these search terms has been conducted in the Wikis source. The results are displayed on the left side of the page in a list 63 of related documents and a condensed view 72 of a selected related document 65 is shown on the right side of the page. A user can click on the Full View icon 66 to see the full view of the related document displayed. In this case the selected related document 65 is the Wikipedia entry/webpage for “Google Toolbar.”

When the list 63 of related documents appears after a search is conducted, the researcher then has the ability to select the star icon 67 associated with each document retrieved from the search to add the document to a collection. After at least one document has been added to the collection for a given research project, a Collection tab 68 will appear at the top of the webpage 60 and can be clicked on to view any and all collected documents. A researcher can also click on the paper icon 69 to add a comment specific to any related document found in the search. The comment will appear in the collection in a comment box specific to the related document.

If a researcher determines that a specific related document is extremely relevant, he can simply click on any of the source links also listed next to that reference to conduct a search for documents contained in that source. A search is then conducted utilizing the text of the extremely relevant related document as the search criteria to find related documents in the other source based on the previously described computing process.

For example, if the user determines that the “AOL Toolbar” Wikipedia entry is extremely relevant, he may click on the RFCs icons 71 next to the Wilds icon 70 under the “AOL Toolbar” entry. This causes a search automatically to be performed to find related content in the RFC source that relates to the content contained in the “AOL Toolbar” Wikipedia entry. The previously described computing process utilizes the text of the “AOL Toolbar” Wikipedia webpage/entry as the search criteria in performing a search to uncover related documents in the RFC source.

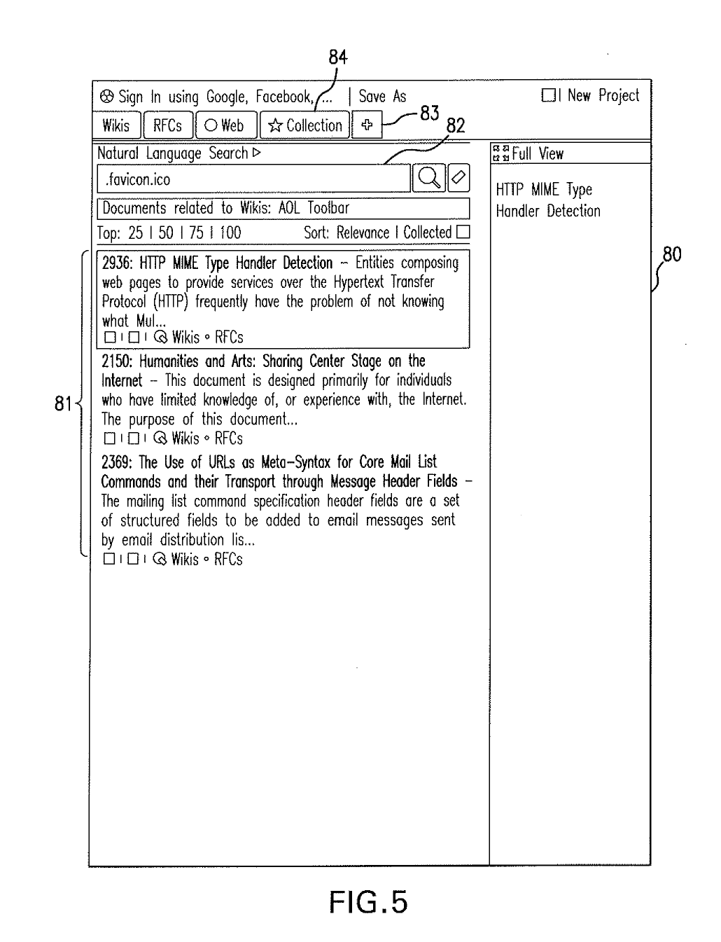

FIG. 5 depicts another interactive webpage for use in conducting a search associated with the preferred embodiment. The interactive webpage 80 shows the results from conducting a search in the RFC source based on the text/entire content of the Wikipedia webpage for “AOL Toolbar.” A list 81 of RFC webpages/documents that contain related information to the “AOL Toolbar” Wikipedia webpage is displayed on the left side of the screen. A condensed view of the first RFC entry from that list is displayed on the right side of the interactive webpage 80.

A researcher also may continue his search by putting search criteria/terms into the natural language search box 82 for another source and continue to add documents to the collection. If the researcher wants to add or subtract the sources to be searched, he can click on the plus symbol icon 83 to alter the different sources that appear on the interactive webpage 80. If a researcher chooses to add a link to the collection of documents, he can simply select the collection tab 84.

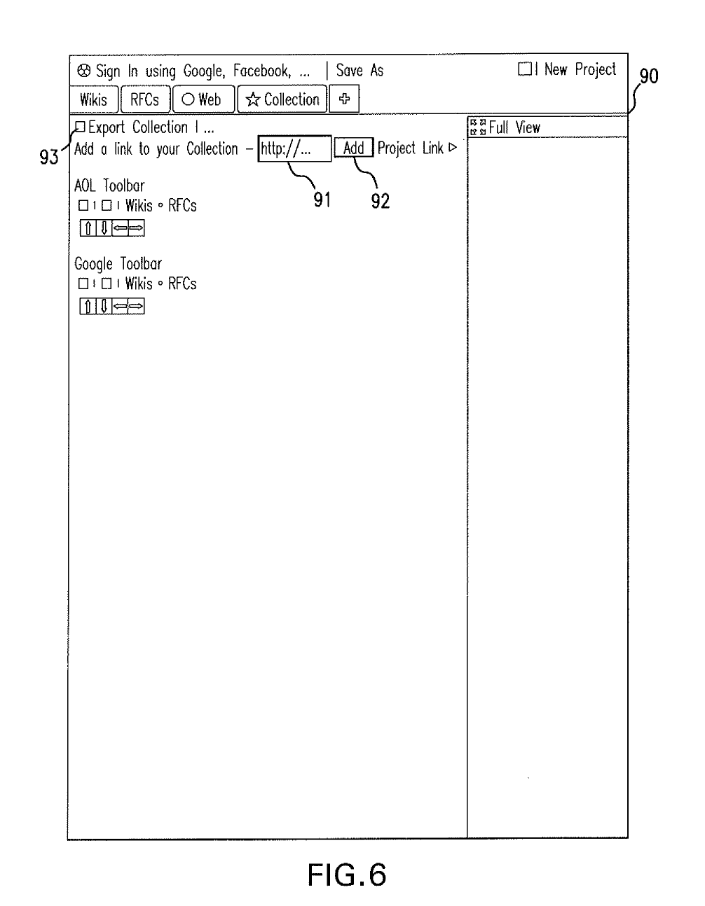

FIG. 6 depicts another interactive webpage for use in conducting a search associated with the preferred embodiment. If a user selects the collection tab, an interactive webpage 90 will appear. The interactive webpage 90 allows a user to type a link into the dialog box 91 and select the additional link tab 92 if the user chooses to add a specific link to his collection. Alternatively, the researcher could simply select the export collection link 93 to permit the collection to be shared with others. The entire collection can then be sent via single URL to another individual who could then view the contents of all documents in the collection by selecting the URL.

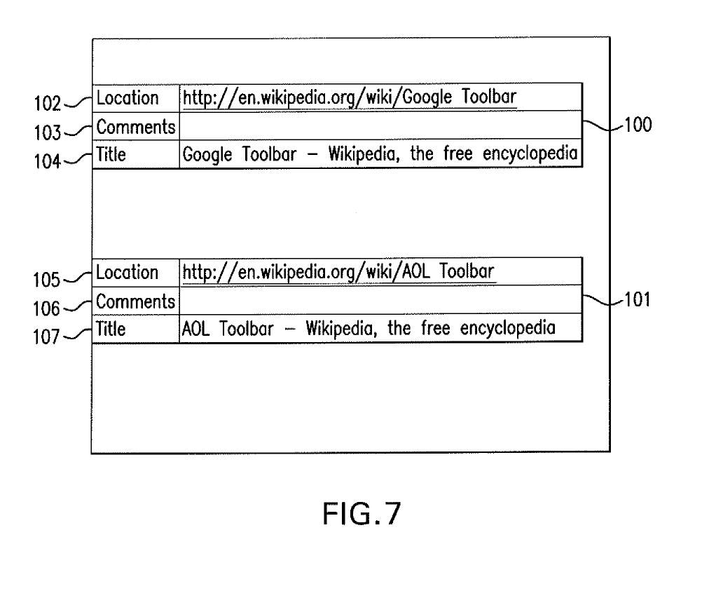

FIG. 7 shows a webpage displaying a collection. When a user selects the URL containing the collection, each individual document/webpage in the collection will be displayed with a table associated therewith. In FIG. 7, Table 100 is associated with the Wikipedia webpage for “Google Toolbar” and table 101 is associated with the Wikipedia webpage for “AOL Toolbar.” Table 100 has a Location field 102, Comments field 103 and Title field 104. Likewise, table 101 has a Location field 105, Comments field 106 and Title field 107. The Location field shows the URL associated with each collected document. The Comments field displays any comments entered by the user related to the collected document, and the Title gives the title of each document in the collection. In certain embodiments, the entire text of the document/webpage will be displayed beneath the table for each document/webpage.

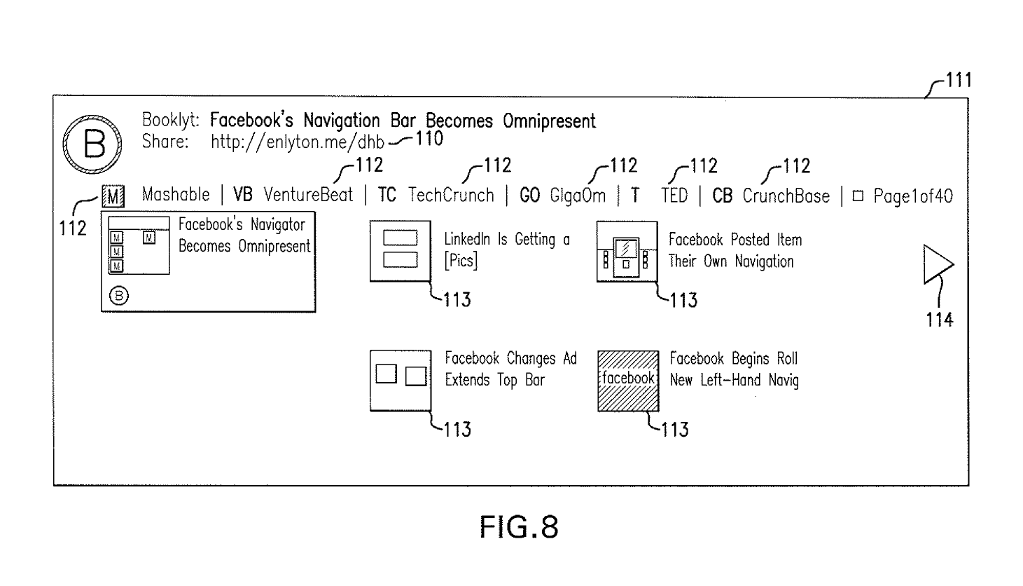

FIG. 8 displays a webpage displaying an electronic magazine (electronic document collection) that can be stored and shared via a single URL. The URL 110 is listed at the top of the webpage 111. The various sources 112 searched are also shown at the top of the webpage 111. The electronic magazine is a data collection created by utilizing the computing process of the present invention. The electronic magazine contains webpages/documents found via searches of the sources 112 listed at the top of the webpage 111. The search criteria or search terms involve the entire document/webpage shown first in the list. In FIG. 8, all of the text from a webpage entitled “Facebook's Navigation Bar Becomes Omnipresent” contained in the Mashable.com source served as the search criteria/terms and all sources 112 were searched using this search criterion to create the electronic magazine with related documents 113 from each source 112 displayed. In FIG. 8, forty results were returned but only some are displayed. A user can click on the arrow 114 on the right side to view more results.

The URL 110 associated with the electronic magazine is completely portable. Anyone that clicks on the URL 110 will be directed to the electronic magazine (collection). The content in the electronic magazine is unique and updated to deliver new content or sources because each time it is opened, the search is conducted based on the current content of the webpage being used as the search criteria and any new documents available in any of the sources may be added to the electronic magazine each time it is opened. A publisher can simply add a link on its webpage that permits an electronic magazine to be created based on the content contained in the current webpage as the search criteria. Depending on default conditions or user specifications, the sources searched may be limited or may be anything on the World Wide Web.

The URLs associated with the electronic magazine are portable and can be shared with anyone across any social or messaging platform. The content related to the original page being searched in the electronic magazine is always updated so the electronic magazine is always fresh and not static. There is no active user participation required from the user (rating, identifying, reviewing, ranking etc.) associated with creating and viewing the electronic magazine.

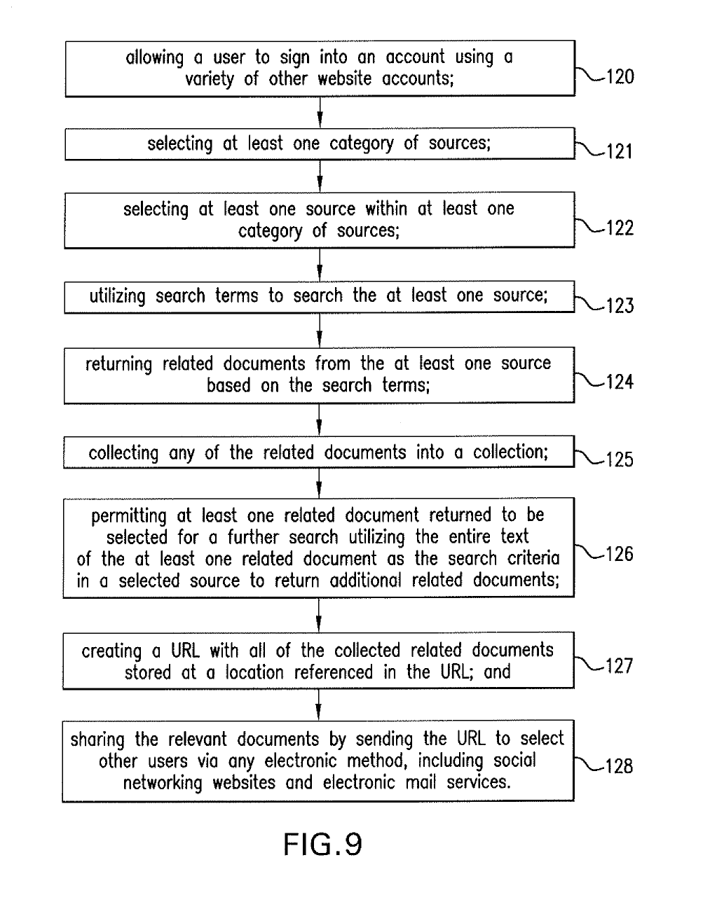

FIG. 9 depicts the preferred methodology of searching, collecting, storing and sharing electronic documents. The preferred methodology may include the steps of: allowing a user to sign into an account using a variety of other website accounts 120; selecting at least one category of sources 121; selecting at least one source 122 (i.e. a dataset/collection of documents) within at least one category of sources; utilizing search terms to search the at least one source 123; returning related documents from the at least one source based on the search terms 124; collecting any of the related documents into a collection 125; permitting a related document returned to be selected for a further search utilizing the text of the related document as the search terms/criteria in a selected source to return additional related documents 126; and creating a URL with all of the collected related documents stored at a location referenced in the URL 127.

The step of permitting the related document returned to be selected for a further search utilizing the text of the related document as the search criteria in a selected source to return additional related documents may involve: parsing out the relevant text from any markup in the related document and all documents in the selected source; lowercasing or uppercasing all letters in the text of the related document and all documents in the source; correcting misspellings of words in the related document and all documents in the source; determining tokens in the related document and all documents in the source; removing tokens that are stopwords in the related document and all documents in the source; stemming each token in the related document and all documents in the source; transforming phrases into individual tokens in the related document and all documents in the source; associating each token with particular sections of the related document and all documents in the source; obtaining a frequency count of the tokens in the related document and all documents in the source; transforming the count of any given token based on the sections it is associated with in the related document and all documents in the source; normalizing the counts of the tokens between the related document and all documents in the source; transforming the counts of the tokens in ways deemed appropriate for the language or nature of the dataset for the related document and all documents in the source; calculating other statistics that apply to each token in the related document and all documents in the source; inverting the data such that each token has a set of documents it resides in, along with the associated counts and statistics; and determining a numeric value that measures the magnitude of each token's significance in the source.

The step of permitting the related document returned to be selected for a further search utilizing the text of the related document as the search terms/criteria in a selected source to return additional related documents may further involve: comparing each token's count in the related document to its matching token's count in all other documents in the source wherein the magnitude of closeness of the two counts has a directly proportional contribution to the magnitude of the similarity score between the related document and any other given document in the source; determining which tokens are present in the related document but not present in other documents and vice versa in the source and including an inversely proportional contribution to the magnitude of the similarity score between the related document and another document based on the magnitude of each such tokens' count and the total number of each such tokens; utilizing a token's value of significance to include a directly proportional contribution to the magnitude of the similarity score based on the closeness of a token's count between the related document and each other document in the source; sorting the set of similarity scores from the source; and displaying the similarity scores from the source in ascending or descending order.

While it will quite often be the case that a researcher will wish to conduct a search utilizing the entire content/text of a document as the search criteria, it is also possible in certain instances that only a portion of text from a document or text from multiple documents or text input by a user will be used as the search criteria. In such a situation, the computing process will simply utilize such text in creating tokens and comparing such tokens to the documents in a source.

The step of collecting any of the related documents into a collection may involve identifying the related documents to be collected from each source. The step of collecting documents may also be performed to collect additional related documents after any search, including after a further search is performed utilizing the entire text of the at least one related document.

The preferred methodology may further involve sharing the relevant documents by sending the URL to select other users via any electronic method, including social networking websites and electronic mail services 128.

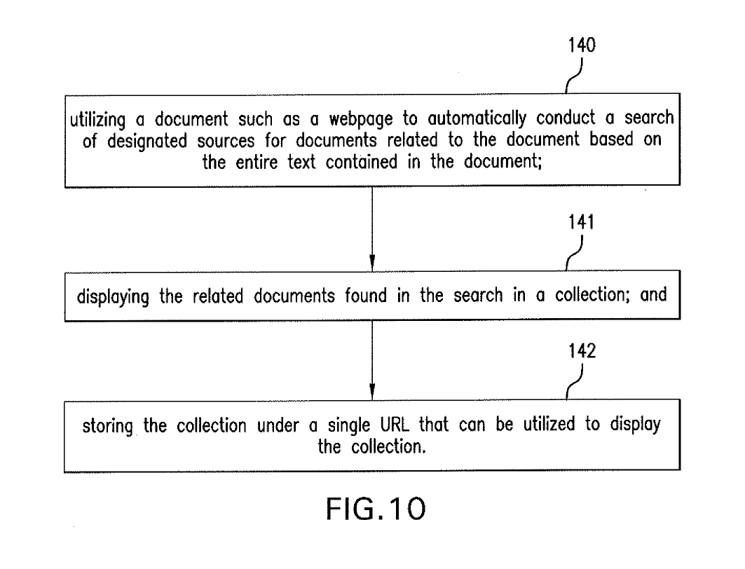

FIG. 10 depicts the preferred methodology of creating an electronic collection of related documents from a variety of sources based on the entire text of a single electronic document. The methodology may include: utilizing a document such as a webpage to automatically conduct a search of designated sources for documents related to the document based on the entire text contained in the document 140; displaying the related documents found in the search in a collection 141; and storing the collection under a single URL that can be utilized to display the collection 142. A collection of related documents can be automatically curated into the form of an XML (Extensible Markup Language) file that can be linked or associated with the URL. The collection of related documents can be dynamically updated by periodically and, in some cases, automatically re-running searches based on the document/webpage and using the preferred searching methodology to include newly added documents in the designated sources.

The step of utilizing a document such as a webpage to automatically conduct a search of designated sources for documents related to the document based on the entire text contained in the document involves: parsing out the relevant text from any markup in the document and all documents in the designated sources; lowercasing or uppercasing all letters in the text of the document and all documents in the designated sources; correcting misspellings of words in the document and all documents in the designated sources; determining tokens in the document and all documents in the designated sources; removing tokens that are stopwords in the document and all documents in the designated sources; stemming each token in the document and all documents in the designated sources; transforming phrases into individual tokens in the document and all documents in the designated sources; associating each token with particular sections of the document and all documents in the designated sources; obtaining a frequency count of the tokens in the document and all documents in the designated sources; transforming the count of any given token based on the sections it is associated with in the document and all documents in the designated sources; normalizing the counts of the tokens between the document and all documents in the designated sources; transforming the counts of the tokens in ways deemed appropriate for the language or nature of the dataset for the document and all documents in the designated sources; calculating other statistics that apply to each token in the document and all documents in the designated sources; inverting the data such that each token has a set of documents it resides in, along with the associated counts and statistics; and determining a numeric value (value of significance) that measures the magnitude of each token's significance in the source.

The step of utilizing a document such as a webpage to automatically conduct a search of designated sources for documents related to the document based on the entire text contained in the document may further involve: comparing each token's count in the document to its matching token's count in all other documents in the designated sources wherein the magnitude of closeness of the two counts has a directly proportional contribution to the magnitude of the similarity score between the document and any other given document in the designated sources; determining which tokens are present in the document but not present in other documents and vice versa in the designated sources and including an inversely proportional contribution to the magnitude of the similarity score between the document and another document from the designated sources based on the magnitude of each such tokens' count and the total number of each such tokens; utilizing a token's value of significance to include a directly proportional contribution to the magnitude of the similarity score based on the closeness of a token's count between the document and each other document in the designated sources; sorting the set of similarity scores from the designated sources; and displaying the similarity scores from the designated sources in ascending or descending order.

A default setting or user selected setting could be utilized to create a threshold value for a similarity score that must be achieved for a document to be included in the collection or the maximum/minimum number of documents that can be included in the collection.

A person of skill in the art would readily recognize that steps of the various above-described methods can be performed by programmed computers and the order of the steps is not necessarily critical. Herein, some embodiments are intended to cover program storage devices, e.g., digital data storage media, which are machine or computer readable and encode machine-executable or computer executable programs of instructions where said instructions perform some or all of the steps of methods described herein. The program storage devices may be, e.g., digital memories, magnetic storage media such as magnetic disks or tapes, hard drives, or optically readable digital data storage media. The embodiments are also intended to cover computers programmed to perform said steps of methods described herein.

It will be recognized by those skilled in the art that changes or modifications may be made to the above-described embodiments without departing from the broad inventive concepts of the invention. It should therefore be understood that this invention is not limited to the particular embodiments described herein, but is of the invention as set forth in the claims.

What is claimed is:

1. A device for electronically searching a source of documents for related documents utilizing text as a search criteria comprising:
(a) a memory containing a set of instructions; and
(b) a processor for processing the set of instructions wherein the set of instructions include instructions for: determining tokens in the text used as the search criteria and in documents in the source; obtaining a frequency count of the tokens for the text used as the search criteria and documents in the source; inverting the data related to the tokens such that each token has a set of documents it resides in from the source along with the associated frequency counts; and comparing the frequency count for each token in the text used as the search criteria to its matching frequency count in each document in the source wherein a magnitude of closeness of the frequency count for each token has a directly proportional contribution to the magnitude of a similarity score between the text used as the search criteria and each document in the source.

2. The device of claim 1 wherein the set of instructions further include instructions for parsing out relevant text from any markup language in the text used as the search criteria and all documents in the source.

3. The device of claim 2 wherein the set of instructions further include instructions for one of lowercasing all letters in the text used as the search criteria and all documents in the source and uppercasing all letters in the text used as the search criteria and all documents in the source.

4. The device of claim 3 wherein the set of instructions further include instructions for correcting misspellings of words in the text used as the search criteria and all documents in the source.

5. The device of claim 4 wherein the set of instructions further include instructions for removing tokens that are stopwords from the text used as the search criteria and all documents in the source.

6. The device of claim 5 wherein the set of instructions further include instructions for stemming each token in the text used as the search criteria and all documents in the source.

7. The device of claim 6 wherein the set of instructions further include instructions for transforming phrases into individual tokens in the text used as the search criteria and all documents in the source.

8. The device of claim 7 wherein the set of instructions further include instructions for associating each token with a particular section in the text used as the search criteria and all documents in the source.

9. The device of claim 8 wherein the set of instructions further include instructions for transforming the frequency count of any token based on the section it is associated with in the text used as the search criteria and all documents in the source.

10. The device of claim 9 wherein the set of instructions further include instructions for normalizing the frequency counts of the tokens for the text used as the search criteria and all documents in the source.

11. The device of claim 10 wherein the set of instructions further include instructions for transforming the frequency counts of the tokens to account for the importance of a word in the language for the text used as a search criteria and all documents in the source.

12. The device of claim 11 wherein the set of instructions further include instructions for calculating other statistics that apply to the tokens in the text used as the search criteria and all documents in the source and transforming the frequency counts of the tokens based on the other statistics.

13. The device of claim 12 wherein the set of instructions further include instructions for including an inversely proportional contribution to the magnitude of the similarity score between the text used as the search criteria and each document in the source based on the number of tokens which are present in the text used as the search criteria but not present in each document in the source and the number of tokens which are not present in the text used as the search criteria but are present in each document in the source.

14. The device of claim 13 wherein the set of instructions further include instructions for determining a numeric value that measures the magnitude of each token's value of significance in the source.

15. The device of claim 14 wherein the set of instructions further include instructions for utilizing the numeric value of significance for each token to include a directly proportional contribution to the magnitude of the similarity score between the text used as the search criteria and each other document in the source.

16. The device of claim 15 wherein the similarity score is perfect only when all of the token counts in the text used as the search criteria match all of the token counts in a document in the source and all of the token counts in the document in the source match all of the token counts in the text used as the search criteria and all token values of significance in the text used as the search criteria and the document are equal to the maximum value in the entire set of values of significance.

17. The device of claim 15 wherein the set of instructions further include instructions for sorting a set of similarity scores between the text used as the search criteria and all the documents in the source and wherein the set of instructions further include instructions for displaying the set of similarity scores between the text used as the search criteria and all the documents in the source in one of ascending order and descending order.

18. The device of claim 17 wherein the set of instructions further include instructions for collecting any of the documents in the source into a collection.

19. The device of claim 18 wherein collecting any of the documents in the source into a collection involves identifying the documents to be stored from the source.

20. The device of claim 18 wherein the set of instructions further include instructions for creating a Uniform Resource Locator (URL) with the collection stored at a location referenced in the URL.

21. The device of claim 20 wherein the set of instructions further include instructions for exporting the collection of documents by sending the URL associated with the collection to other selected users.

22. A device comprising:
(a) a memory containing a set of instructions; and
(b) a processor for processing the set of instructions wherein the set of instructions include instructions for: utilizing the text of a document to conduct a search of at least one designated source for documents related to the document which involves: determining tokens in the document and in documents in the at least one designated source; obtaining a frequency count of the tokens for the document and documents in the at least one designated source; inverting the data related to the tokens such that each token has a set of documents it resides in from the at least one designated source along with the associated frequency counts; and comparing the frequency count for each token in the document to its matching frequency count in each document in the at least one designated source wherein a magnitude of closeness of the frequency count for each token has a directly proportional contribution to the magnitude of a similarity score between the document and each document in the at least one designated source; and displaying the related documents based on the similarity scores in a collection.

23. The device of claim 22 further comprising instructions for storing the collection under a single Uniform Resource Locator (URL) that can be utilized to display the collection.

24. A computer-implemented method utilizing a processor to electronically search a source of documents for related documents to text used as a search criteria comprising the steps of:
(a) determining tokens in the text used as the search criteria and in documents in the source;
(b) obtaining a frequency count of tokens for the text used as the search criteria and documents in the source;
(c) inverting the data related to tokens such that each token has a set of documents it resides in from the source along with the associated frequency counts; and
(d) comparing the frequency count for each token in the text used as the search criteria to its matching frequency count in each document in the source wherein a magnitude of closeness of the frequency count for each token has a directly proportional contribution to the magnitude of a similarity score between the text used as the search criteria and each document in the source.

25. The method of claim 24 further including the step of: parsing out relevant text from any markup language in the text used as the search criteria and all documents in the source.

26. The method of claim 25 further including the step of: one of lowercasing all letters in the text used as the search criteria and all documents in the source and uppercasing all letters in the text used as the search criteria and all documents in the source.

27. The method of claim 26 further including the step of: correcting misspellings of words in the text used as the search criteria and all documents in the source.

28. The method of claim 27 further including the step of: removing tokens that are stopwords from the text used as the search criteria and all documents in the source.

29. The method of claim 28 further including the step of: stemming each token in the text used as the search criteria and all documents in the source.

30. The method of claim 29 further including the step of: transforming phrases into individual tokens in the text used as the search criteria and all documents in the source.

31. The method of claim 30 further including the step of: associating each token with a particular section in the text used as the search criteria and all documents in the source.

32. The method of claim 31 further including the step of: transforming the frequency count of any token based on the section it is associated with in the text used as the search criteria and all documents in the source.

33. The method of claim 32 further including the step of: normalizing the frequency counts of the tokens for the text used as the search criteria and all documents in the source.

34. The method of claim 33 further including the step of: transforming the frequency counts of the tokens to account for the importance of a word in the language of the text used as the search criteria and all documents in the source.

35. The method of claim 34 further including the step of: calculating other statistics that apply to each token in the text used as the search criteria and all documents in the source and transforming the frequency counts of the tokens based on the other statistics.

36. The method of claim 35 further including the step of: including an inversely proportional contribution to the magnitude of the similarity score between the text used as the search criteria and each document in the source based on the number of tokens which are present in the text used as the search criteria but not present in each document in the source and the number of tokens which are not present in the text used as the search criteria but are present in each document in the source.

37. The method of claim 36 further including the step of: determining a numeric value that measures the magnitude of each token's value of significance in the source.

38. The method of claim 37 further including the step of: utilizing the numeric value of significance for each token to include a directly proportional contribution to the magnitude of the similarity score between the text used as the search criteria and each other document in the source.

39. The method of claim 38 further including the step of: calculating a perfect similarity score when all of the token counts in the text used as the search criteria match all of the token counts in a document in the source and all of the token counts in the document in the source match all of the token counts in the text used as the search criteria and all tokens' values of significance in the text used as the search criteria and the document are equal to the maximum value in the entire set of values of significance in the source.

40. The method of claim 38 further including the steps of: sorting a set of similarity scores between the text used as the search criteria and all the documents in the source and displaying the set of similarity scores between the text used as the search criteria and all the documents in the source in one of ascending order and descending order.

41. The computer-implemented method of claim 40 further comprising the step of:
collecting any of the documents in the source into a collection.

42. The computer-implemented method of claim 41 further comprising the step of:
creating a Uniform Resource Locator (URL) with the collection stored at a location referenced in the URL.

43. The computer-implemented method of claim 41 wherein the step of collecting any of the documents in the source into the collection involves identifying the documents to be collected.

44. The computer-implemented method of claim 42 further comprising the step of:
sharing the collection by sending the URL to select other users via any electronic method.

45. A computer-implemented method utilizing a processor for searching for documents comprising the steps of:
(a) utilizing text of a document to conduct a search of at least one designated source for documents related to the document which involves: determining tokens in the document and in documents in the at least one designated source; obtaining a frequency count of the tokens for the document and documents in the at least one designated source; inverting the data related to the tokens such that each token has a set of documents it resides in from the at least one designated source along with the associated frequency counts; and comparing the frequency count for each token in the document to its matching frequency count in each document in the at least one designated source wherein a magnitude of closeness of the frequency count for each token has a directly proportional contribution to the magnitude of a similarity score between the document and each document in the at least one designated source; and
(b) displaying the related documents based on the similarity scores in a collection.

46. The computer-implemented method of claim 45 further comprising the step of:
storing the collection under a URL that can be utilized to display the collection.

47. The computer-implemented method of claim 46 further comprising the step of:
sharing the collection by sending the URL via one of an electronic mail system and a social networking platform.
